(19) United States
(12) Patent Application Publication
(10) Pub. No.: US 2013/0031118 A1
(43) Pub. Date: Jan. 31, 2013

(54) INFORMATION PROCESSING SYSTEM, INFORMATION PROCESSING METHOD, PROGRAM, AND NON-TRANSITORY INFORMATION STORAGE MEDIUM

(71) Applicants: Seiichi TAKAMURA, Tokyo (JP); Osamu OTA, Tokyo (JP); Takayuki ISHIDA, Tokyo (JP); Hideaki WATANABE, Tokyo (JP); Jun HIROI, Tokyo (JP)

(72) Inventors: Seiichi TAKAMURA, Tokyo (JP); Osamu OTA, Tokyo (JP); Takayuki ISHIDA, Tokyo (JP); Hideaki WATANABE, Tokyo (JP); Jun HIROI, Tokyo (JP)

(73) Assignee: SONY COMPUTER ENTERTAINMENT INC., Tokyo (JP)

(21) Appl. No.: 13/554,135

(22) Filed: Jul. 20, 2012

(30) Foreign Application Priority Data
Jul. 26, 2011 (JP) 2011-163371

(51) Int. Cl. G06F 17/30

(52) U.S. Cl. 707/758; 707/E17.014

(57) ABSTRACT

Provided is a technology that enables detection of a change in a feature of a page. An analysis unit identifies a content of a page whose content changes with a lapse of time. A feature change determination unit determines based on contents of the page identified at different timings whether or not a feature of the identified page has changed.

### CROSS-REFERENCE TO RELATED APPLICATION

The present application claims priority from Japanese application JP 2011-163371 filed on Jul. 26, 2011, the content of which is hereby incorporated by reference into this application.

### BACKGROUND OF THE INVENTION

1. Field of the Invention

The present invention relates to an information processing system, an information processing method, a program, and a non-transitory information storage medium.

2. Description of the Related Art

There exists an information processing system such as an electronic bulletin board system that provides pages for discussion threads to which users' posts are submitted one by one. Contents of the pages provided by such an information processing system are changed by the users posting comments every moment with a lapse of time. Further, hot topics in the discussion threads may change with a lapse of time.

Further, there exists a search site that enables a search to be made through the information processing system such as an electronic bulletin board system for a discussion thread that matches a condition relating to a keyword.

### SUMMARY OF THE INVENTION

However, according to the related art, the users cannot be provided with changes in features of the pages, such as changes in the hot topics on the pages, even when the contents of the pages are changed with a lapse of time.

The present invention has been made in view of the above-mentioned problem, and an object of some embodiments of the invention is to enable detection of a change in a feature of a page.

In order to solve the above-mentioned problem, according to an exemplary embodiment of the present invention, there is provided an information processing system, including: an identifying unit that repeatedly identifies a content of a page whose content changes with a lapse of time; and a determination unit that determines based on contents of the page identified at different timings whether or not a feature of the identified page has changed.

Further, according to an exemplary embodiment of the present invention, there is provided an information processing method, including: repeatedly identifying a content of a page whose content changes with a lapse of time; and determining, based on contents of the page identified at different timings, whether or not a feature of the identified page has changed.

Further, according to an exemplary embodiment of the present invention, there is provided a program stored in a non-transitory computer readable information storage medium, which is to be executed by a computer, the program including instructions to: repeatedly identify a content of a page whose content changes with a lapse of time; and determine based on contents of the page identified at different timings whether or not a feature of the identified page has changed.

Further, according to an exemplary embodiment of the present invention, there is provided a non-transitory computer readable information storage medium storing a program which is to be executed by a computer, the program including instructions to: repeatedly identify a content of a page whose content changes with a lapse of time; and determine based on contents of the page identified at different timings whether or not a feature of the identified page has changed.

According to the exemplary embodiments of the present invention, it is determined based on the contents of the page identified at different timings whether or not the feature of the identified page has been changed, which enables the detection of the change in the feature of the page.

According to the exemplary embodiment of the present invention, the information processing system further includes: a reception unit that receives designation of a condition relating to a keyword; and a search unit that repeatedly executes a search for a page that matches the condition on which the search is executed on at least one of search target pages, each of the search target pages having a content changed with a lapse of time, in which: the identifying unit identifies the content of a page retrieved by the search unit; and the determination unit determines based on contents of the page retrieved at different timings whether or not a feature of the retrieved page has changed.

Further, according to the exemplary embodiment of the present invention, the information processing system further includes an important word extraction unit that extracts an important word included in the retrieved page, and, after the important word is extracted by the important word extraction unit, the search unit adds the important word to the condition as a part thereof and executes the search for the page.

Further, according to the exemplary embodiment of the present invention, the each of the search target pages includes a plurality of comments associated with registration times, and the determination unit determines whether or not the feature of the plurality of comments included in one of the search target pages has changed.

Further, according to the exemplary embodiment of the present invention, the search target page is a discussion thread, and the determination unit determines whether or not the feature of the plurality of comments included in one discussion thread has changed.

Further, according to the exemplary embodiment of the present invention, the determination unit determines whether or not the feature of the page has changed based on a comparison of a number of times that the plurality of comments are registered alternately by a plurality of users.

Further, according to another exemplary embodiment of the present invention, there is provided an information processing system, including: a page generation unit that generates a first page on which information representative of a second page whose content changes with a lapse of time is placed; and a page output unit that outputs the first page generated by the page generation unit, in which the page generation unit generates the first page on which the representative information is placed so that it is distinguishable whether or not a feature of the second page has changed.

### BRIEF DESCRIPTION OF THE DRAWINGS

In the accompanying drawings:

FIG. 1 is a diagram illustrating an overall configuration of a computer network according to an embodiment of the present invention;

FIG. 2 is a diagram illustrating an example of a main page;

FIG. 3 is a diagram illustrating an example of a search history list page;

FIG. 4 is a diagram illustrating an example of a snapshot page;

FIG. 5 is a diagram illustrating an example of a comment list page;

FIG. 6 is a functional block diagram illustrating an example of functions implemented by a search system according to the embodiment of the present invention; and

FIG. 7 is a diagram schematically illustrating an example of snapshot data.

### DETAILED DESCRIPTION OF THE INVENTION

Hereinafter, an embodiment of the present invention is described in detail below referring to the drawings.

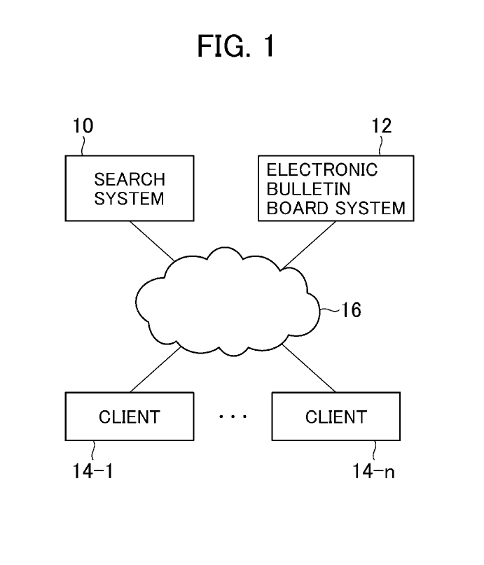

FIG. 1 is a diagram illustrating an overall configuration of a computer network 16 according to the embodiment of the present invention. As illustrated in FIG. 1, a search system 10, an electronic bulletin board system 12, and clients 14 (14-1 to 14-n), which are all constructed based on computers, are connected to the computer network 16 such as the Internet. The search system 10, the electronic bulletin board system 12, and the clients 14 can communicate to/from one another.

The search system 10, which is a server functioning as an information processing system of this embodiment, executes a search for data registered in the electronic bulletin board system 12.

The electronic bulletin board system 12 is, for example, a Web server for providing an electronic bulletin board service. The electronic bulletin board system 12 provides a plurality of discussion thread pages that are respectively associated with mutually different URLs. In this embodiment, data serving as a basis for generating the discussion thread page is stored in a storage unit included in the electronic bulletin board system 12.

In this embodiment, in principle, one discussion thread page is associated with one topic on an electronic bulletin board. The electronic bulletin board system 12 allows users thereof to create a new discussion thread page or post a comment to the already-created discussion thread page (submit a new comment). Therefore, contents of the discussion thread page are changed with a lapse of time. Further, the electronic bulletin board system 12 according to this embodiment allows the users thereof who wish to reply to a posted comment to post another comment, which is associated with an identifier of the comment to be replied to, to the electronic bulletin board system 12. Such a post is referred to as “reply post”.

In this embodiment, the search system 10 executes a search for the discussion thread page (search for data serving as the basis for generating the discussion thread page) registered in the electronic bulletin board system 12, to thereby acquire data associated with the discussion thread page from the electronic bulletin board system 12. Then, the search system 10 according to this embodiment manages the above-mentioned data thus acquired from the electronic bulletin board system 12 as discussion thread data. The discussion thread data corresponds to the data associated with the discussion thread page, and in this embodiment, includes, for example, a thread ID being an ID of a discussion thread, title data indicating a title of a thread, and a URL associated with the discussion thread page. Further, the discussion thread data includes at least one individual post data piece. The individual post data piece represents data associated with a comment posted by the user and registered in the electronic bulletin board system 12. The individual post data piece includes an individual post ID that is uniquely assigned in ascending order within the discussion thread to which the post is to be submitted, a user ID being an identifier of the user who submitted the post, registration date/time data indicating a date/time at which the comment was registered by the post, comment data representing the content of the post, and a parent individual post ID being the individual post ID associated with the comment to be replied to. Note that, in this embodiment, the individual post data piece of a post that is not a reply post has a null set as the value of the parent individual post ID.

Each of the search system 10 and the electronic bulletin board system 12 includes, for example, a control unit that is a program control device such as a central processing unit (CPU) which operates in accordance with a program installed in the own device, a storage unit that is a storage element such as a read-only memory (ROM) or a random access memory (RAM), or a hard disk drive, and a communication unit that is a communication interface such as a network board. Those elements are interconnected to each other via a bus. The storage units of the search system 10 and the electronic bulletin board system 12 store programs executed by the control units of the own devices. The storage units of the search system 10 and the electronic bulletin board system 12 also operate as work memories of the own devices.

The client 14, which is a computer utilized by a user of the search system 10 or the electronic bulletin board system 12, is, for example, a personal computer, a game console, a television set, a portable game device, or a portable information device. The client 14 includes, for example, a control device such as a CPU, a storage device such as a storage element including a ROM or a RAM, or a hard disk drive, an output device such as a display or a speaker, an input device such as a game controller, a touch pad, a mouse, a keyboard, or a microphone, a communication device such as a network board, and an optical disc drive that reads data from an optical disc (computer readable information storage medium) such as a digital versatile disc (DVD)-ROM or Blu-ray (registered trademark) disc.

The client 14 of this embodiment has a web browser installed therein in advance. According to this embodiment, the client 14 accesses the search system 10 through the web browser, and inputs a user ID and a password to login. Then, when the client 14 accesses a predetermined URL, a screen corresponding to the predetermined URL is displayed on the display of the client 14. After the entry of the user ID and the password, the search system 10 can determine the user ID of the user who utilizes the client 14 by, for example, referring to a cookie.

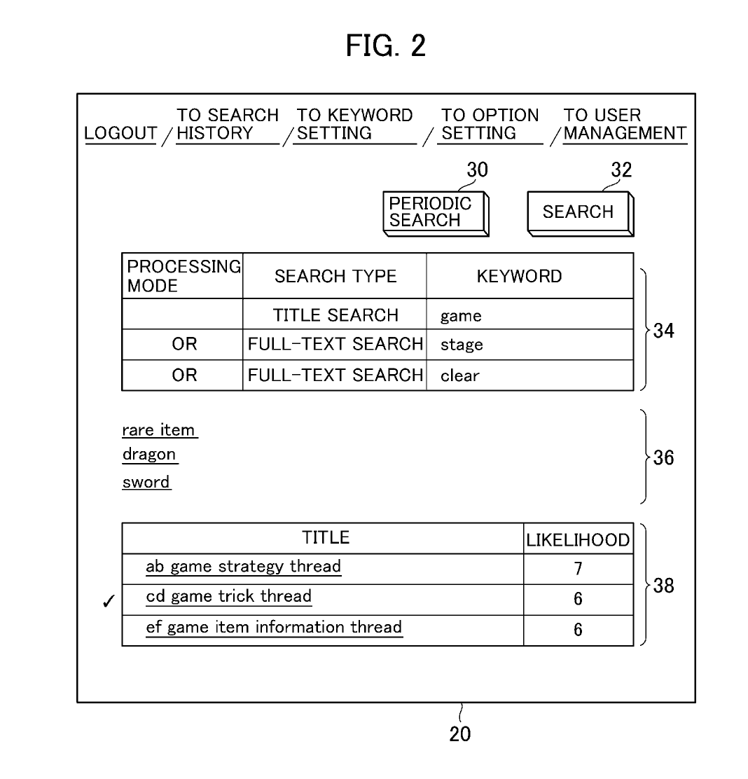

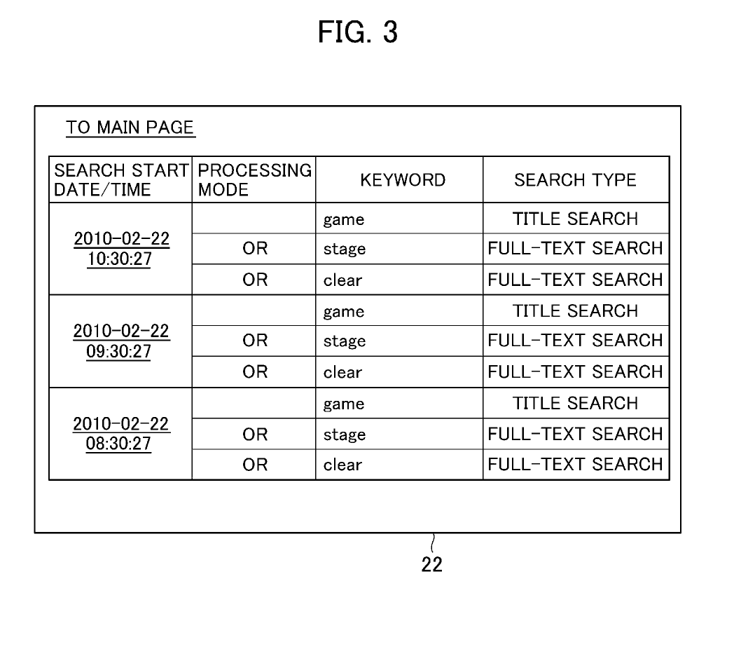

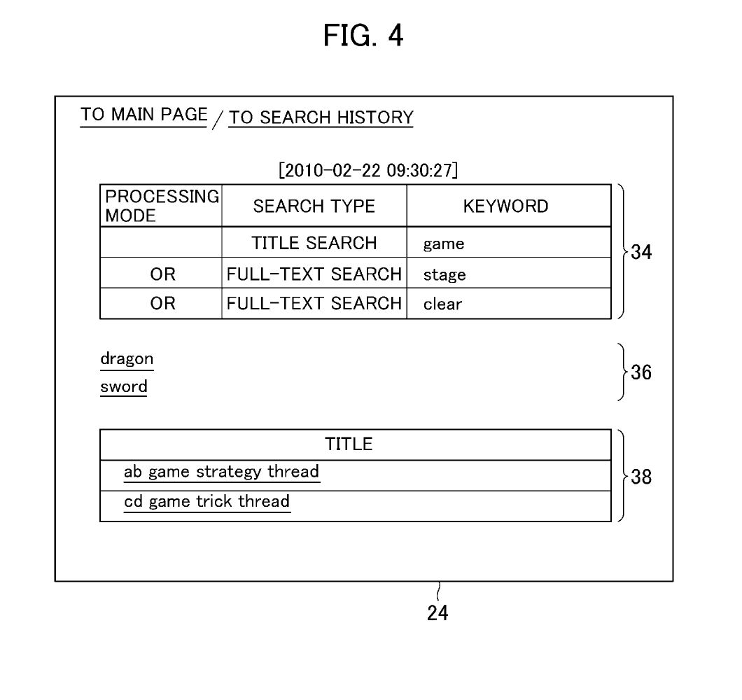

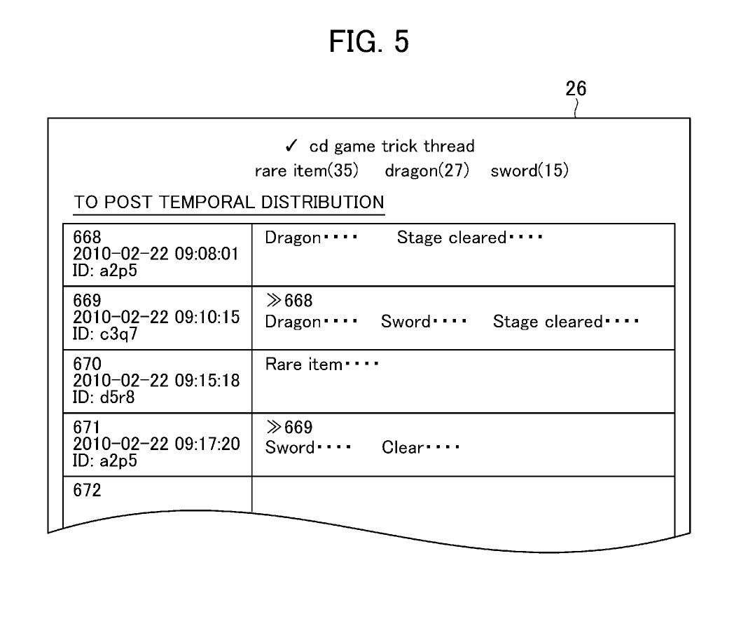

FIG. 2 is a diagram illustrating an example of a main page 20 provided by the search system 10 according to this embodiment. FIG. 3 is a diagram illustrating an example of a search history list page 22 provided by the search system 10 according to this embodiment. FIG. 4 is a diagram illustrating an example of a snapshot page 24 provided by the search system 10 according to this embodiment. FIG. 5 is a diagram illustrating an example of a comment list page 26 provided by the search system 10 according to this embodiment.

The main page 20 includes a periodic search button 30, a search button 32, a keyword conditional expression placement area 34 in which a keyword conditional expression that has been used for a search for the data registered in the electronic bulletin board system 12 is placed, an important word placement area 36 in which an important word extracted from the comment data to be subjected to an analysis described later is placed, a passing thread title placement area 38 in which information (in this embodiment, title) representing the discussion thread (passing thread) in which a feature amount of the comment indicated by the comment data to be subjected to the analysis described later satisfies a predetermined condition is placed in a list format, links to other pages, and a logout link for executing logout processing when clicked on by the user. In this embodiment, the titles and the values of the likelihood of the discussion threads having a value calculated based on the feature amount (in this embodiment, expressed as value of “likelihood”) which is equal to or larger than a predetermined value (passing score) (the titles and the values of the likelihood of the passing threads) are placed in the passing thread title placement area 38 in a list format. Further, in this embodiment, the important word placed in the important word placement area 36 and the title placed in the passing thread title placement area 38 are set as links. Further, in this embodiment, a mark indicating that the feature has changed (check mark in the example of FIG. 2) is placed on the left side of the title of the discussion thread data determined to have the feature of the discussion thread data changed in the last search compared to searches performed up to then. In this manner, the titles of the discussion thread data are placed on the main page 20 according to this embodiment in such a manner that it can be distinguished whether or not the feature of the discussion thread data has changed.

A predetermined number (three in the example of FIG. 3) of combinations of a search start date/time and the keyword conditional expression regarding the searches for data registered in the electronic bulletin board system 12 which have been performed so far are placed on the search history list page 22 in reverse chronological order from the last date/time indicated by the search start date/time. Further, in this embodiment, the search start date/time included in the search history list page 22 is set as a link. Further, the search history list page 22 includes a link to the main page 20.

The snapshot page 24 is a page for providing information relating to a search selected by the user from among the information relating to the searches for the data registered in the electronic bulletin board system 12 which have been performed so far. The snapshot page 24 also includes the search start date/time regarding the search selected by the user, the keyword conditional expression placement area 34 in which the keyword conditional expression that has been used for the search is placed, the important word placement area 36 in which the important word extracted from the comment data to be subjected to the analysis described later is placed, and the passing thread title placement area 38 in which the information (in this embodiment, title) representing the discussion thread in which the feature amount of the comment indicated by the comment data to be subjected to the analysis described later satisfies the predetermined condition (passing thread) is placed in a list format. Further, the snapshot page 24 includes links to the main page 20 and the search history list page 22. Further, in this embodiment, the mark indicating that the feature has changed is placed on the left side of the title of the discussion thread data determined to have the feature of the discussion thread data changed in the search selected by the user compared to searches performed up to then. In this manner, the titles of the discussion thread data are placed on the snapshot page 24 according to this embodiment in such a manner that it can be distinguished whether or not the feature of the discussion thread data has changed.

In this embodiment, the important word extracted in the last search is placed in the important word placement area 36 of the main page 20. This is the same as the information placed in the important word placement area 36 of the snapshot page 24 that provides information relating to the last search. Further, in this embodiment, the titles of the passing threads regarding the last search are placed in the passing thread title placement area 38 of the main page 20. This is the same as the information placed in the passing thread title placement area 38 of the snapshot page 24 that provides information relating to the last search.

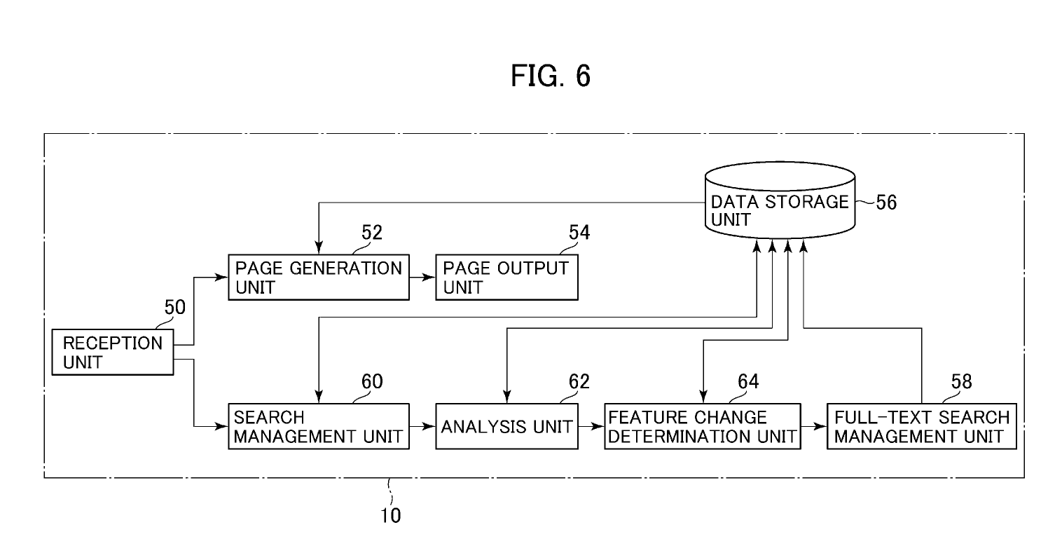

The comment list page 26 is a page on which a predetermined number of comments within the discussion thread designated by the user (in this embodiment, discussion thread corresponding to the title of the passing thread clicked on by the user) are placed in a list format. The important word extracted from the comment data and an appearance count of the important word are placed on the comment list page 26. The example of FIG. 5 indicates that, from the comment data subjected to the analysis, the important word “rare item” has been extracted thirty-five times, the important word “dragon” has been extracted twenty-seven times, and the important word “sword” has been extracted fifteen times. Further, the comments represented by the comment data are placed on the comment list page 26 along with the individual post ID associated with the comment data, a registration date/time indicated by the registration date/time data associated with the comment data, and the user ID associated with the comment data. Further, in this embodiment, the mark indicating that the feature has changed (check mark in the example of FIG. 6) is placed on the left side of the title regarding the comment list page 26 corresponding to the discussion thread data determined to have the feature of the discussion thread data changed.

In addition thereto, the search system 10 also provides the user with a keyword conditional expression setting page that allows the user to set the keyword conditional expression, an important title list page on which the titles for the discussion thread data from which the important word designated by the user has been extracted are placed in a list format, a post temporal distribution graph page on which a graph representing a transition of a post count per unit time with respect to the discussion thread designated by the user is placed, and the like.

In this embodiment, for example, when the user clicks on a link, the client 14 transmits an output request for a page set as a link target to the link. Then, the search system 10 receives the output request. Then, the search system 10 generates the requested page and transmits the page to the client 14. Then, the client 14 outputs and displays the page to/on a display via a Web browser. In this manner, in this embodiment, various pages are displayed on the display of the client 14. Therefore, in this embodiment, under the condition that the main page 20 or the snapshot page 24 are displayed on the display of the client 14, the title for the discussion thread data whose feature has changed is distinguishingly displayed.

In this embodiment, when the user logs in to the search system 10, the main page 20 is displayed on the client 14. Further, when the user clicks on the link to the keyword conditional expression setting page (in FIG. 2, represented as “to keyword setting”) which is included on the main page 20, the keyword conditional expression setting page is displayed on the client 14. Then, the user can perform designation of the keyword conditional expression on the keyword conditional expression setting page. The keyword conditional expression used in this embodiment is a conditional expression formed of at least one condition, and in a case of a plurality of conditions, the conditions are coupled to one another with a logical operator (in this embodiment, AND or OR). Then, each condition is formed of a combination of a search type (in this embodiment, title search for searching the titles of the discussion threads or full-text search for searching a full text of the registered comments) and a keyword. In this embodiment, the logical operator that couples the conditions is referred to as “processing mode”. After the setting of the keyword conditional expression is finished, the set keyword conditional expression is now placed in the keyword conditional expression placement area 34 of the main page 20. FIG. 3 indicates that the keyword conditional expression for searching for the discussion thread that satisfies any one of the conditions: (1) the title includes the word “game”; (2) the comment includes the word “stage”; and (3) the comment includes the word “clear” is set.

When the user clicks on the link to the search history list page 22 (in FIG. 2, represented as “to search history”) which is included on the main page 20, the search history list page 22 is displayed on the client 14. Further, when the user clicks on an important word placed in the important word placement area 36 of the main page 20, the important title list page including a list of the titles for the discussion thread data from which the important word has been extracted is displayed on the client 14. Further, when the user clicks on a title placed in the passing thread title placement area 38 of the main page 20, the comment list page 26 in which a predetermined number of comments of the posts in the list regarding the discussion thread corresponding to the title are placed in reverse chronological order from the newest one is displayed on the client 14.

Further, when the user clicks on a search start date/time included in the search history list page 22, the snapshot page 24 regarding a result of the search started at the search start date/time are displayed on the client 14.

Further, when the user clicks on an important word placed in the important word placement area 36 of the snapshot page 24, the important title list page including the list of the titles for the discussion thread data from which the important word has been extracted is displayed on the client 14. Further, when the user clicks on a title placed in the passing thread title placement area 38 of the snapshot page 24, the comment list page 26 regarding the discussion thread corresponding to the title is displayed on the client 14.

Further, in this embodiment, the comment list page 26 includes a link to the post temporal distribution graph page (in FIG. 5, represented as “to post temporal distribution”). When the user clicks on the link, the post temporal distribution graph page on which the graph representing the transition of the post count per unit time with respect to the discussion thread associated with the comment list page 26 is placed is displayed on the client 14.

FIG. 6 is a functional block diagram illustrating an example of functions implemented by the search system 10 of this embodiment. Note that, in the search system 10 of this embodiment, other functions are implemented in addition to those illustrated in FIG. 6. As illustrated in FIG. 6, the search system 10 functionally includes a reception unit 50, a page generation unit 52, a page output unit 54, a data storage unit 56, a full-text search management unit 58, a search management unit 60, an analysis unit 62, and a feature change determination unit 64. The data storage unit 56 is implemented mainly by the storage unit included in the search system 10. The other elements are implemented mainly by the control unit included in the search system 10.

Those functions are implemented by executing a program of this embodiment in the search system 10 that is a computer. This program may be downloaded from another computer via a communication interface through a computer communication network, or may be stored in a computer readable information storage medium such as an optical disc (e.g., compact disc (CD)-ROM or DVD-ROM) or a universal serial bus (USB) memory, and then installed in the search system 10 via an optical disc drive or a USB port.

The reception unit 50 receives various requests (for example, output request for a page and execution request for a search described later) from the client 14. Further, as described above, the reception unit 50 also receives the designation of the keyword conditional expression from the client 14. The page generation unit 52 generates a page in response to the request from the client 14. The page output unit 54 outputs the page generated by the page generation unit 52 to the client 14. The data storage unit 56 stores various kinds of data used by the search system 10 according to this embodiment.

In this embodiment, the full-text search management unit 58 acquires (crawls) the data corresponding to the discussion thread pages registered in the electronic bulletin board system 12, updates or creates an index for the full-text search, and outputs a full-text search result thereof to the data storage unit 56.

The search management unit 60 outputs keyword conditional expression data indicating the designated keyword conditional expression to the data storage unit 56 in response to the designation of the keyword conditional expression received by the reception unit 50. In the generation of the main page 20, the page generation unit 52 places the keyword conditional expression indicated by the keyword conditional expression data stored in the data storage unit 56 in the keyword conditional expression placement area 34.

Further, in the search system 10 according to this embodiment, a search mode of any one of an alert mode and a repute mode is set in advance, and data indicating the set search mode is stored in the data storage unit 56.

Under the condition that the user clicks on the periodic search button 30 placed on the main page 20, the client 14 transmits a periodic search execution request to the search system 10. Under the condition that the reception unit 50 of the search system 10 receives the periodic search execution request, the search system 10 starts executing a periodical search for data corresponding to the discussion thread pages that match the conditions expressed by the keyword conditional expression indicated by the keyword conditional expression data stored in the data storage unit 56. Here, in the case where the alert mode is set in the search system 10, the search management unit 60 performs a search for the discussion thread data once per hour, and in the case where the repute mode is set in the search system 10, the search management unit 60 performs a search for the discussion thread data once per six hours.

Further, under the condition that the user clicks on the search button 32 placed on the main page 20, the client 14 transmits a search execution request to the search system 10. Under the condition that the reception unit 50 of the search system 10 receives the search execution request, the search system 10 starts executing a search for the discussion thread data that matches the conditions expressed by the keyword conditional expression indicated by the keyword conditional expression data stored in the data storage unit 56. In this case, the search is performed only one time.

In this embodiment, to execute the title search, the search management unit 60 outputs an output request to the electronic bulletin board system 12 to request the electronic bulletin board system 12 for the data corresponding to the discussion thread pages in which the title of the discussion thread matches the individual condition regarding the title search set in the keyword conditional expression. In response to the output request, the electronic bulletin board system 12 outputs the data corresponding to the discussion thread pages that match the condition to the search system 10. The above-mentioned data is managed by the search management unit 60 as retrieved thread data. Then, the search management unit 60 acquires the retrieved thread data from the electronic bulletin board system 12.

Meanwhile, to execute the full-text search, the search management unit 60 acquires the data in which the comment indicated by the comment data matches the individual condition regarding the full-text search set in the keyword conditional expression from among the data stored in the data storage unit 56 as the full-text search result by the full-text search management unit 58. The above-mentioned data is managed by the search management unit 60 as the retrieved thread data. In this manner, in this embodiment, the acquisition of the discussion thread data, the updating or creating of the index, and the like performed by the full-text search management unit 58 are performed asynchronously to and independently of the search executed by the search management unit 60.

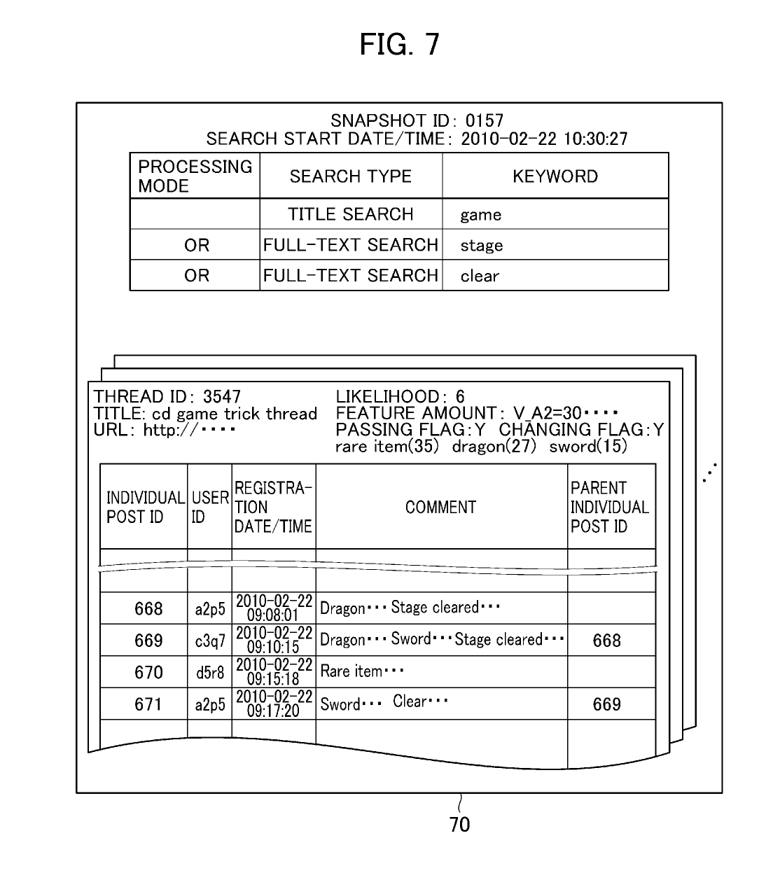

Then, the search management unit 60 performs a logical operation, which is based on the logical operator represented by the processing mode included in the keyword conditional expression, for the discussion thread data acquired on the individual condition by the above-mentioned title search or the full-text search, to thereby identify the discussion thread data that matches the conditions indicated by the keyword conditional expression as a final search result. In this manner, for example, the discussion thread data corresponding to the discussion threads that satisfy the conditions expressed by the keyword conditional expression exemplified in FIG. 3 is identified as the final search result. Then, in this embodiment, the search management unit 60 generates snapshot data 70 including at least one discussion thread data piece identified as the final research result by the search management unit 60 in one search, an identifier (snapshot ID), the search start date/time data indicating a date/time at which the search was started, and the keyword conditional expression data indicating the keyword conditional expression used for the search. Then, the search management unit 60 outputs the generated snapshot data 70 to the data storage unit 56 (see FIG. 7). FIG. 7 is a diagram schematically illustrating an example of the snapshot data 70. Note that, in addition to the above-mentioned data, the snapshot data 70 illustrated in FIG. 7 includes the feature amount, the value of the likelihood, a passing flag, a changing flag, important word data, and appearance count data, which are described later in detail.

Under the condition that the search performed by the search management unit 60 is finished, the analysis unit 62 executes an analysis of the discussion thread data stored in the data storage unit 56 as the snapshot data 70. Note that, in this embodiment, the discussion thread data to be subjected to the analysis of a body text is limited to the discussion thread data regarding the thread in which the post count within three hours immediately before a search start time point is equal to or larger than a predetermined number (for example, three) in the case of the alert mode, and limited to the discussion thread data regarding the thread in which the post count within twenty-four hours immediately before the search start time point is equal to or larger than the predetermined number (for example, three) in the case of the repute mode.

The analysis unit 62 identifies the content of the discussion thread data limited in the above-mentioned manner, and performs calculation of each of the following feature amounts (1) to (13). Therefore, the analysis unit 62 according to this embodiment also plays the role of an identifying unit that identifies the content of a page whose content changes with a lapse of time. Then, the analysis unit 62 examines whether or not the calculated feature amount satisfies a predetermined condition, and under the condition that the condition is satisfied, the value of the likelihood is incremented by one. Here, the likelihood is assumed to have an initial value of zero. Note that, the following feature amounts (1) to (9) relate to a structure of the comment, and the feature amounts (10) to (13) relate to a word included in the comment. Note that, in this embodiment, the analysis unit 62 handles the comments posted within three hours immediately before the search start time point as the posts to be subjected to the analysis in the case of the alert mode, and handles the comments posted within twenty-four hours immediately before the search start time point as the posts to be subjected to the analysis in the case of the repute mode.

(1) Regular visitor density: represents an extent to which a plurality of persons appear within a predetermined number of posts with each of the persons appearing a plurality of times. For example, the analysis unit 62 repeats processing for “calculating a number V_A1 of users who submitted a predetermined number A3 or larger number of posts including a predetermined number A2 or larger number of question-type posts (for example, posts including a sentence that ends with “?”) among the posts submitted successively by a predetermined post count A1” within a range of the posts to be subjected to the analysis while shifting the range of the posts submitted successively by the predetermined post count A1 by a predetermined post count (for example, by one post), to thereby calculate the value V_A1 within the respective ranges. Then, the analysis unit 62 identifies a maximum value V_A2 of the value V_A1 calculated for the respective ranges as the regular visitor density. Then, the analysis unit 62 increments the value of the likelihood of the discussion thread data to be subjected to the analysis by one under the condition that the value V_A2 is equal to or larger than a predetermined threshold value th_A2.

(2) Multiple concurrence factor: represents an extent to which a large number of entangled chains of short posts occur within a short period of time. For example, the analysis unit 62 repeats processing for “calculating a number V_B1 of combinations of a given post and the reply post submitted within a predetermined time B2 after the given post among the posts submitted within a predetermined period B1” within the range of the posts to be subjected to the analysis while shifting the range of the posts submitted within the predetermined period B1 by a predetermined time (for example, by one minute), to thereby calculate the number V_B1 within the respective ranges. Then, the analysis unit 62 identifies a number V_B2 of the above-mentioned ranges exhibiting the number V_B1 equal to or larger than a predetermined number B3 as the multiple concurrence factor. Then, the analysis unit 62 increments the value of the likelihood of the discussion thread data to be subjected to the analysis by one under the condition that the value V_B2 is equal to or larger than a predetermined threshold value th_B2.

(3) Conversational ball rolling factor: represents an extent to which a plurality of users alternately post comments. For example, the analysis unit 62 repeats processing for “identifying a user who submitted a predetermined number C3 or larger number of posts including a predetermined number C2 or larger number of question-type posts (for example, post including a sentence that ends with “?”) among the posts submitted successively by a predetermined post count C1, then arranging the user's posts in ascending order of the post time, and calculating a number V_C1 of groups assuming that one group represents a group of posts submitted successively by the same user” within the range of the posts to be subjected to the analysis while shifting the range of the posts submitted successively by the predetermined post count C1 by a predetermined post count (for example, by one post), to thereby calculate the number V_C1 within the respective ranges. Then, the analysis unit 62 identifies a maximum value V_C2 of the calculated value V_C1 as the conversational ball rolling factor. Then, the analysis unit 62 increments the value of the likelihood of the discussion thread data to be subjected to the analysis by one under the condition that the value V_C2 is equal to or larger than a predetermined threshold value th_C2.

(4) Agreement factor: represents an extent to which a comment is posted with the intention of agreeing with another person's post. For example, the analysis unit 62 repeats processing for “calculating a post count V_D1, a count of posts including a predetermined magic word (for example, “me as well”) among the posts submitted successively by a predetermined post count D1” within the range of the posts to be subjected to the analysis while shifting the range of the posts submitted successively by the predetermined post count D1 by a predetermined post count (for example, by one post), to thereby calculate the number V_D1 within the respective ranges. Then, the analysis unit 62 identifies a maximum value V_D2 of the calculated value V_D1 as the agreement factor. Then, the analysis unit 62 increments the value of the likelihood of the discussion thread data to be subjected to the analysis by one under the condition that the value V_D2 is equal to or larger than a predetermined threshold value th_D2.

(5) Normality: represents an extent to which the content of a comment makes sense with existence of some sentence structure and some logical structure. For example, the analysis unit 62 repeats processing for “calculating a number V_E1 of comments which do not include ASCII art (including a number E2 or larger number of the same symbols in series) or a half-width katakana and which have a byte count equal to or larger than a predetermined number E3 among the posts submitted successively by a predetermined post count E1” within the range of the posts to be subjected to the analysis while shifting the range of the posts submitted successively by the predetermined post count E1 by a predetermined post count (for example, by one post), to thereby calculate the number V_E1 within the respective ranges. Then, the analysis unit 62 identifies a maximum value V_E2 of the calculated value V_E1 as the normality. Then, the analysis unit 62 increments the value of the likelihood of the discussion thread data to be subjected to the analysis by one under the condition that the value V_E2 is equal to or larger than a predetermined threshold value th_E2.

(6) Reaction-to-long-sentence successiveness: represents an extent to which a plurality of short-sentence reply posts are successively submitted as a reply to a comment formed of long sentences. For example, assuming that the successive replies to a post is referred to as “chain”, the analysis unit 62 calculates a number V_F1 of reply posts submitted in reply to an initial post (which also include another reply post to the reply post) among all chains within the range of the posts to be subjected to the analysis, the initial post being a comment having a byte count equal to or larger than a predetermined number F1, the reply post being a comment having a byte count equal to or smaller than a predetermined number F2. Then, the analysis unit 62 identifies a maximum value V_F2 of the calculated value V_F1 as the reaction-to-long-sentence successiveness. Then, the analysis unit 62 increments the value of the likelihood of the discussion thread data to be subjected to the analysis by one under the condition that the value V_F2 is equal to or larger than a predetermined threshold value th_F2.

(7) Gratitude factor: represents an extent to which a comment posted with the intention of expressing gratitude is included in the posts submitted within a fixed segment. For example, the analysis unit 62 repeats processing for “calculating a number V_G1 of comments including a predetermined magic word belonging to a type of gratitude (for example, “thank you”; however, excluding a predetermined NG word (for example, “thank you so much”)) among the posts submitted successively by a predetermined post count G1” within the range of the posts to be subjected to the analysis while shifting the range of the posts submitted successively by the predetermined post count G1 by a predetermined post count (for example, by one post), to thereby calculate the number V_G1 within the respective ranges. Then, the analysis unit 62 identifies a maximum value V_G2 of the calculated value V_G1 as the gratitude factor. Then, the analysis unit 62 increments the value of the likelihood of the discussion thread data to be subjected to the analysis by one under the condition that the value V_G2 is equal to or larger than a predetermined threshold value th G2.

(8) Short-sentence successiveness: represents an extent to which a short-sentence comment does not appear successively. For example, the analysis unit 62 repeats processing for “calculating a number V_H1 of times that a comment having a byte count equal to or smaller than a predetermined number H2 appears successively among the posts submitted successively by a predetermined post count H1” within the range of the posts to be subjected to the analysis while shifting the range of the posts submitted successively by the predetermined post count H1 by a predetermined post count (for example, by one post), to thereby calculate the number V_H1 within the respective ranges. Then, the analysis unit 62 identifies a maximum value V_H2 of the calculated value V_H1 as the short-sentence successiveness. Then, the analysis unit 62 increments the value of the likelihood of the discussion thread data to be subjected to the analysis by one under the condition that the value V_H2 is equal to or smaller than a predetermined threshold value th_H2.

(9) Instantaneous speed: represents an extent to which a situation that the post count per unit time is large occurs. For example, the analysis unit 62 repeats processing for “examining whether or not a post was submitted a predetermined number 12 or larger number of times within a predetermined period I1” within the range of the posts to be subjected to the analysis while shifting the range of the posts submitted within the predetermined period I1 by a predetermined time (for example, by one minute), to thereby examine within the respective ranges whether or not a post was submitted the predetermined number I2 or larger number of times. Then, the analysis unit 62 identifies a number V_I1 of times that it has been examined that a post was submitted the predetermined number I2 or larger number of times, as the instantaneous speed. Then, the analysis unit 62 increments the value of the likelihood of the discussion thread data to be subjected to the analysis by one under the condition that the value V_I1 is equal to or larger than a predetermined threshold value th_I1.

(10) Magic word appearance frequency: represents an appearance frequency of a predetermined magic word. For example, examples of the magic word in the case of the alert mode include “download”, “update”, “started”, “specifications”, and “support”, while examples of the magic word in the case of the repute mode include “release”, “thank you”, and “the same”. Note that, the magic words in the alert mode and the magic words in the repute mode may partially overlap each other. Note that, in this embodiment, the magic words are stored in the data storage unit 56 in advance. The analysis unit 62 identifies, for example, a number mwa of times that the magic word is included in the comment data of the discussion thread data, as the magic word appearance frequency. Then, the analysis unit 62 increments the value of the likelihood of the discussion thread data to be subjected to the analysis by one under the condition that the number mwa is equal to or larger than a predetermined number th_mwa.

(11) Magic word recent appearance frequency: represents a recent appearance frequency of a predetermined magic word. the analysis unit 62 identifies, for example, a number mwr of times that the magic word is included in the comment data indicating the recently-posted comments (for example, comments posted within one hour immediately before the search start time point) among the comment data of the discussion thread data, as the magic word recent appearance frequency. Then, the analysis unit 62 increments the value of the likelihood of the discussion thread data to be subjected to the analysis by one under the condition that the number mwr is equal to or larger than a predetermined number th_mwr.

(12) User-designated keyword appearance frequency: represents the appearance frequency of the keyword set in a keyword conditional expression. Note that, in this embodiment, a predetermined word assumed to be common is not to be counted in the appearance frequency. The analysis unit 62 identifies, for example, a number kwa of times that the keyword to be counted is included in the comment data of the discussion thread data, as the user-designated keyword appearance frequency. Then, the analysis unit 62 increments the value of the likelihood of the discussion thread data to be subjected to the analysis by one under the condition that the number kwa is equal to or larger than a predetermined number th_kwa.

(13) User-designated keyword recent appearance frequency: represents the recent appearance frequency of a keyword set in the keyword conditional expression. The analysis unit 62 identifies, for example, a number kwr of times that the keyword is included in the comment data indicating the recently-posted comments (for example, comments posted within one hour immediately before the search start time point) among the comment data of the discussion thread data, as the user-designated keyword recent appearance frequency. Then, the analysis unit 62 increments the value of the likelihood of the discussion thread data to be subjected to the analysis by one under the condition that the number kwr is equal to or larger than a predetermined number th kwr.

In the above-mentioned manner, the analysis unit 62 calculates any one of integers 0 to 13 as the value of the likelihood of the discussion thread data. Then, the analysis unit 62 adds the calculated value of the likelihood and the respective feature amounts serving as the basis of the analysis (in the above-mentioned example, V_A2, V_B2, V_C2, V_D2, V_E2, V_F2, V_G2, V_H2, V_I1, mwa, mwr, kwa, and kwr) to the discussion thread data which is included in the snapshot data 70 regarding the search concerned and from which the feature amounts were extracted. Note that, at this time, for the discussion thread exhibiting the value of the likelihood equal to or larger than the predetermined value (passing score) (passing thread), the analysis unit 62 sets “Y” as a value of the passing flag included in the above-mentioned discussion thread data. Note that, in this embodiment, for the discussion thread exhibiting the value of the likelihood smaller than the predetermined value (passing score) (rejected thread), the analysis unit 62 sets “N” as the value of the passing flag included in the above-mentioned discussion thread data.

Then, the analysis unit 62 uses a morphological analysis technology and a technical term extraction technology to extract, from the discussion thread data on the passing thread, the important word included in the comment data within the range of the posts to be subjected to the analysis (for example, word included in the comment data a predetermined number or larger number of times). Therefore, the analysis unit 62 according to this embodiment also plays the role of an important word extraction unit for extracting an important word. Then, the analysis unit 62 adds the important word data, which indicates at least one important word extracted from the comment data within the range of the posts to be subjected to the analysis, and the appearance count data indicating the appearance count thereof to the discussion thread data which is included in the snapshot data 70 regarding the search concerned and from which the important word was extracted.

Note that, the analysis unit 62 may be configured to extract the important word from the discussion thread data on the passing thread which satisfies predetermined selection criteria.

Here, in the alert mode, for example, the important word is extracted from the discussion thread data that satisfies both two conditions: (1) at least one actual-experience-based comment (e.g., “I did X and then Y happened”) is included; and (2) at least two comments including an agreeing expression (e.g., “happen to me as well”) following the actual-experience-based comment are included (however, a comment determined as attempting to find a fault or making fun of the other is not counted).

Meanwhile, in the repute mode, for example, the important word is extracted from the discussion thread data that satisfies both two conditions: (1) at least one comment being any one of the actual-experience-based comment, a suggesting comment (e.g., “you should X” or “would anyone Y for me”), and a discovery-based comment (e.g., I did X and then Y became possible) is included; and (2) at least five comments of reactions (such as affirmative comment, negative comment, question, or alternative idea) to the above-mentioned comment are included, or at least one comment including useful additional information is included.

Further, the search management unit 60 may be configured to update the keyword conditional expression data stored in the data storage unit 56 so that at least one of the important words extracted in the above-mentioned manner is included in the condition for the periodical search performed after the important word is extracted. The search management unit 60 may be configured to, for example, couple the extracted important word to the other keyword with an AND condition or an OR condition. Then, the search management unit 60 may be configured to execute the subsequent searches based on the updated keyword conditional expression.

The feature change determination unit 64 determines, in this embodiment, whether or not the feature of the discussion thread data has changed (that is, whether or not the feature of the discussion thread page has changed) based on the contents of the discussion thread data included in the snapshot data 70 regarding the respective searches performed at different timings. In this embodiment, after the above-mentioned important word is extracted, which is followed by the search, the feature change determination unit 64 performs the above-mentioned determination on the respective discussion thread data pieces included in the snapshot data 70 regarding the search.

In this embodiment, the feature change determination unit 64 identifies, for example, the important word data included in the discussion thread data to be subjected to the determination (hereinafter, referred to as “current thread data”). Then, the feature change determination unit 64 identifies the snapshot data obtained when the discussion thread corresponding to the above-mentioned discussion thread data was identified as the passing thread last time. Then, the feature change determination unit 64 identifies the important word data included in the discussion thread data for the identified snapshot data 70 (hereinafter, referred to as “previous thread data”). Then, the feature change determination unit 64 compares the important word indicated by the important word data included in the previous thread data and the important word indicated by the important word data included in the current thread data, and under the condition that the number of common words is equal to or smaller than a predetermined number (for example, equal to or smaller than two), determines that the feature of the discussion thread data has changed. As described above, even in the case of the same discussion thread, the comments from which the important word is to be extracted are limited to the comments posted within several hours immediately before the search start time point. Hence, according to the search system 10 according to this embodiment, it is possible to determine whether or not the feature of the comments included in one discussion thread data piece has changed.

Then, for the discussion thread data determined as having the feature of the discussion thread data changed, the feature change determination unit 64 sets “Y” as the value of the changing flag included in the discussion thread data. Note that, in this embodiment, for the discussion thread data determined as not having the feature of the discussion thread data changed, the feature change determination unit 64 sets “N” as the value of the changing flag included in the discussion thread data.

In this embodiment, the page generation unit 52 generates the main page 20 based on the snapshot data 70 regarding the last search stored in the data storage unit 56. The page generation unit 52 identifies, for example, the discussion thread data included in the snapshot data 70 regarding the last search. Then, the page generation unit 52 places the important word, which is indicated as the important word data in any one of the discussion thread data pieces, in the important word placement area 36. Further, the page generation unit 52 places, for example, the title indicated by the title data included in the discussion thread data which is included in the snapshot data 70 regarding the last search and for which the passing flag is set to have the value of “Y” and the value of the likelihood included in the above-mentioned discussion thread data, in the passing thread title placement area 38. At this time, the page generation unit 52 places, for example, the title indicated by the title data included in the discussion thread data which is included in the snapshot data 70 regarding the last search and for which the changing flag is set to have the value of “Y”, in the passing thread title placement area 38 so that it is distinguishable that the feature has changed (for example, the mark indicating that the feature has changed is placed on the left side of the title that satisfies the above-mentioned condition). In this manner, the page generation unit 52 according to this embodiment generates the main page 20 on which the information representative of the discussion thread page is placed so that it is distinguishable whether or not the feature of the discussion thread page has changed. Note that, even for the discussion thread data which is included in the snapshot data 70 regarding the last search and for which the passing flag is set to have the value of “N”, under the condition that the value of the changing flag set for the discussion thread data is “Y”, the page generation unit 52 may be configured to place the title indicated by the title data included in the above-mentioned discussion thread data in the passing thread title placement area 38.

Further, the page generation unit 52 generates the search history list page 22 based on a predetermined number (for example, three) or smaller number of snapshot data 70 pieces in reverse chronological order from the last date/time indicated by the search start date/time data. The page generation unit 52 identifies the snapshot data 70 items regarding a predetermined number (three in the example of FIG. 3) of search results in reverse chronological order from the last date/time indicated by the search start date/time data. Then, the dates/times indicated by the search start date/time data included in the respective snapshot data 70 pieces and the keyword conditional expressions are placed on the search history list page 22 so that the last date/time indicated by the search start date/time data is placed at the top.

Further, in this embodiment, when the user clicks on the search start date/time included in the search history list page 22, the client 14 transmits the output request for the snapshot page 24 regarding the search started at the search start date/time to the search system 10. Then, the reception unit 50 of the search system 10 receives the output request. Then, the page generation unit 52 identifies the snapshot data 70 regarding the search designated by the user. Then, the page generation unit 52 places the date/time indicated by the search start date/time data included in the above-mentioned snapshot data 70 and the keyword conditional expression indicated by the keyword conditional expression data on the snapshot page 24. Further, the page generation unit 52 identifies, for example, the discussion thread data included in the identified snapshot data 70. Then, the page generation unit 52 places the important word, which is indicated as the important word data in any one of the discussion thread data pieces, in the important word placement area 36. Further, the page generation unit 52 places, for example, the title indicated by the title data included in the discussion thread data which is included in the identified snapshot data 70 and for which the passing flag is set to have the value of “Y”, in the passing thread title placement area 38. At this time, the page generation unit 52 places, for example, the title indicated by the title data included in the discussion thread data which is included in the identified snapshot data 70 and for which the changing flag is set to have the value of “Y”, in the passing thread title placement area 38 flag so that it is distinguishable that the feature has changed (for example, the mark indicating that the feature has changed is placed on the left side of the title that satisfies the above-mentioned condition). In this manner, the page generation unit 52 according to this embodiment generates the snapshot page 24 on which the information representative of the discussion thread page is placed so that it is distinguishable whether or not the feature of the discussion thread page has changed. Note that, even for the discussion thread data which is included in the identified snapshot data 70 and for which the passing flag is set to have the value of “N”, under the condition that the value of the changing flag set for the discussion thread data is “Y”, the page generation unit 52 may be configured to place the title indicated by the title data included in the above-mentioned discussion thread data, in the passing thread title placement area 38.

Further, in this embodiment, the page generation unit 52 generates the comment list page 26 based on the snapshot data 70 stored in the data storage unit 56. In this embodiment, when the user clicks on the title of the passing thread included in the main page 20, the page generation unit 52 identifies the discussion thread data which is included in the snapshot data 70 regarding the last search and which includes the clicked title as the title data. Meanwhile, when the user clicks on the title of the passing thread included in the snapshot page 24, the page generation unit 52 identifies the discussion thread data which is included in the snapshot data 70 serving as the basis for generating the above-mentioned snapshot page 24 and which includes the clicked title as the title data.

Then, the page generation unit 52 places the title indicated by the title data included in the identified discussion thread data, the important word indicated by the important word data included in the identified discussion thread data, the appearance count indicated by the appearance count data included in the identified discussion thread data, and the link to the post temporal distribution graph page, on the comment list page 26. Here, under the condition that the value of the changing flag set for the discussion thread data is “Y”, the page generation unit 52 places the mark indicating that the feature has changed on the left side of the title.

Then, from among the individual post data pieces included in the identified discussion thread data, the page generation unit 52 identifies a predetermined number or smaller number of individual post data pieces in reverse chronological order from the last date/time indicated by the registration date/time data. Then, information (in the example of FIG. 5, individual post ID, registration date/time, user ID, and comment) included in the respective individual post data pieces is placed on the comment list page 26 so that the earliest date/time indicated by the registration date/time data is placed at the top. Here, the page generation unit 52 places the parent individual post ID along with a quotation symbol at the head of a comment field in a case where the parent individual post ID of the individual post data piece is included.

Further, in this embodiment, when the client 14 transmits an end instruction to end a periodic search to the search system 10, the search system 10 receives the end instruction. Then, the search system 10 brings the specified periodic search to an end.

On the main page 20 exemplified in FIG. 2, for “cd game trick thread”, the check mark is placed on the left side of the title. In this manner, the user can confirm at a glance the important word and the passing thread in the last search, and the discussion thread determined as having the feature changed.

Further, FIG. 4 illustrates the snapshot page 24 regarding a search started at 9:30:27 on Feb. 22, 2010. In the example of FIG. 4, there exists no discussion thread on the left side of the title of which the check mark is placed. For this reason, the user is allowed to know that “cd game trick thread” is not determined as having the feature changed in the search started at 9:30:27 on Feb. 22, 2010 and is determined as having the feature changed in the last search (for example, a search started at 10:30:27 on Feb. 22, 2010).

As described above, according to the search system 10 according to this embodiment, it is possible to detect a change in the feature of the retrieved page, and the user is allowed to know the important word, the passing thread, and whether or not the feature of the discussion thread has changed.

Note that, the present invention is not limited to the above-mentioned embodiment.

For example, the feature change determination unit 64 may be configured to determine that the feature of the discussion thread data has changed when the value of the conversational ball rolling factor included in the current thread data becomes larger (or smaller) than the value of the conversational ball rolling factor included in the previous thread data by the predetermined value (for example, 2) or more.

Further, the feature change determination unit 64 may be configured to determine that the feature of the discussion thread data has changed in a case where there is at least one common word between the important words indicated by the important word data included in the current thread data and the important words indicated by the important word data included in the previous thread data and in a case where the at least one common word includes a word for which the appearance count obtained when the word is currently identified as the search result is two or more times larger than (or one half or less of) the appearance count obtained when the word was identified last time as the search result.

Further, the feature change determination unit 64 may be configured to determine whether or not the feature of the discussion thread data has changed based on a timing at which the discussion thread data was determined as the passing thread. For example, the feature change determination unit 64 may be configured to determine that the feature of the discussion thread data changed in the last search in a case where the discussion thread data determined in the search during the last one week as the passing thread at night (for example, night on holiday) was determined in the last search as the passing thread in the daytime (for example, daytime on weekday).

Further, for example, with regard to the discussion thread data on the passing thread, the analysis unit 62 may use the morphological analysis technology to calculate a feature vector of words and phrases included in the comment indicated by the comment data. Then, the analysis unit 62 may be configured to add the calculated feature vector to the discussion thread data on the above-mentioned passing thread which is included in the snapshot data 70. Then, the feature change determination unit 64 may be configured to determine whether or not the feature of the discussion thread data has changed based on whether or not a difference in the feature vector satisfies a predetermined condition.

Further, the feature change determination unit 64 may be configured to determine whether or not the feature of the discussion thread data has changed based on a result of comparing at least three feature amounts of the discussion thread data included in the snapshot data 70 the search start dates/times of which are different from one another. For example, the feature change determination unit 64 may be configured to determine in the current search that the feature of the discussion thread data has changed in a case where a difference between the value of the conversational ball rolling factor obtained when currently identified as the search result and the value of the conversational ball rolling factor obtained as the search result in the last search is larger than a difference between the value of the conversational ball rolling factor obtained when identified last time as the search result and the value of the conversational ball rolling factor obtained as the search result in the second last search.

Further, the analysis unit 62 may be configured to extract the important word from all the discussion thread data included in the snapshot data 70, instead of extracting the important word only from the passing thread, and add the important word data indicating the extracted important word to the discussion thread data. Further, the feature change determination unit 64 may be configured to determine whether or not the feature of the discussion thread data has changed by comparing the important word indicated as the important word data in the current thread data with the important word indicated as the important word data in the discussion thread data obtained when the discussion thread corresponding to the current thread data was identified last time as the search result.

Further, the feature change determination unit 64 may be configured to determine whether or not the feature of the retrieved page has changed as a whole by comparing the features of the whole discussion thread data included in the snapshot data 70 (for example, comparing the important words indicated as the important word data in any one of the discussion thread data pieces in the above-mentioned manner). Then, the page generation unit 52 may be configured to place a mark indicating to that effect on the main page 20 if it is determined that the feature of the retrieved page has changed as a whole.

Further, the page generation unit 52 may be configured to update the main page 20 so that the title and the like of the rejected thread are included in response to a request performed by the user. In this case, the page generation unit 52 generates the main page 20 that has been updated based on, for example, the discussion thread data other than the passing thread (discussion thread data on the rejected thread). Further, the search system 10 may be configured to update the value of the above-mentioned passing score in response to a request performed by the user. Then, the search system 10 may be configured to set the passing flag for the discussion thread data for the snapshot data 70 to have the value of “Y” under the condition that the value of the likelihood included in the discussion thread data for the snapshot data 70 is equal to or larger than the value of the updated passing score, and set the passing flag for the discussion thread data for the snapshot data 70 to have the value of “N” under the condition that the value of the likelihood included in the discussion thread data for the snapshot data 70 is smaller than the value of the updated passing score.

Further, for example, the feature change determination unit 64 may be configured to notify, when it is determined that the feature of the discussion thread data has changed, the client 14 to that effect by electronic mail.

Further, the search system 10 may be configured to perform a search across the discussion threads that are respectively registered in a plurality of electronic bulletin board systems 12 (for example, plurality of electronic bulletin board systems 12 that are respectively provided by different service providers). Further, the roles to be played by the search system 10 according to this embodiment, the electronic bulletin board system 12, and the client 14 are not limited to the above-mentioned ones. Further, the specific character strings described above and the specific character strings illustrated in the accompanying drawings are merely examples, and the present invention is not limited to those character strings.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An information processing system, comprising:
an identifying unit that repeatedly identifies a content of a page whose content changes with a lapse of time; and
a determination unit that determines based on contents of the page identified at different timings whether or not a feature of the identified page has changed.

2. The information processing system according to claim 1, further comprising:
a reception unit that receives designation of a condition relating to a keyword; and
a search unit that repeatedly executes a search for a page that matches the condition on which the search is executed on at least one of search target pages, each of the search target pages having a content changed with a lapse of time, wherein:
the identifying unit identifies the content of a page retrieved by the search unit; and
the determination unit determines based on contents of the page retrieved at different timings whether or not a feature of the retrieved page has changed.

3. The information processing system according to claim 2, further comprising an important word extraction unit that extracts an important word included in the retrieved page,
wherein, after the important word is extracted by the important word extraction unit, the search unit adds the important word to the condition as a part thereof and executes the search for the page.

4. The information processing system according to claim 2, wherein:
the each of the search target pages includes a plurality of comments associated with registration times; and
the determination unit determines whether or not the feature of the plurality of comments included in one of the search target pages has changed.

5. The information processing system according to claim 4, wherein:
the search target page comprises a discussion thread; and
the determination unit determines whether or not the feature of the plurality of comments included in one discussion thread has changed.

6. The information processing system according to claim 4, wherein the determination unit determines whether or not the feature of the page has changed based on a comparison of a number of times that the plurality of comments are registered alternately by a plurality of users.

7. An information processing system, comprising:
a page generation unit that generates a first page on which information representative of a second page whose content changes with a lapse of time is placed; and
a page output unit that outputs the first page generated by the page generation unit,
wherein the page generation unit generates the first page on which the representative information is placed so that it is distinguishable whether or not a feature of the second page has changed.

8. An information processing method, comprising:
repeatedly identifying a content of a page whose content changes with a lapse of time; and
determining, based on contents of the page identified at different timings, whether or not a feature of the identified page has changed.

9. A program stored in a non-transitory computer readable information storage medium, which is to be executed by a computer, the program including instructions to:
repeatedly identify a content of a page whose content changes with a lapse of time; and
determine based on contents of the page identified at different timings whether or not a feature of the identified page has changed.

10. A non-transitory computer readable information storage medium storing a program which is to be executed by a computer, the program including instructions to:
repeatedly identify a content of a page whose content changes with a lapse of time; and
determine based on contents of the page identified at different timings whether or not a feature of the identified page has changed.
